(19) United States
(12) Patent Application Publication
(10) Pub. No.: US 2016/0286762 A1
(43) Pub. Date: Oct. 6, 2016

(54) EDIBLE PET CHEW WITH BONE-POWDER BASED OUTER LAYER

(71) Applicants: Zuxi Chen, Wenzhou (CN); Zuhua Chen, Wenzhou (CN)

(72) Inventors: Zuxi Chen, Wenzhou (CN); Zuhua Chen, Wenzhou (CN)

(73) Assignee: Wenzhou Yuxiang Pet Product Co., Ltd.

(21) Appl. No.: 15/186,629

(22) Filed: Jun. 20, 2016

Related U.S. Application Data
(63) Continuation of application No. 13/306,009, filed on Nov. 29, 2011, now abandoned.

(51) Int. Cl. A01K 15/02; A23K 50/42; A23K 10/30; A23K 10/26

(52) U.S. Cl. CPC A01K 15/026; A23K 10/26; A23K 50/42; A23K 10/30

(57) ABSTRACT

A pet chew includes an outer layer; and an inner layer, the outer and inner layers being laminated and rolled into a cylindrical shape having knots at both ends, the outer layer including bone powder.

This is a Continuation of U.S. patent application Ser. No. 13/306,009, filed Nov. 29, 2011 and hereby incorporated by reference herein.

The present invention relates to an edible pet chew and a preparation method of same.

### BACKGROUND OF THE INVENTION

At present, edible pet chews produced from the prior art typically are made from rawhide and jerky, for example in the shape of a knotted bone, as described for example in U.S. Pat. No. 5,673,653. Such traditional knotted bone from rawhide, produced for the purpose of teeth grinding and chewing, has the disadvantages of mono-nutrition, excessively hard skin and poor palatability as well as environmental pollution, high cost and an insufficient source of raw materials.

U.S. Pat. No. 7,677,203, describes a knotted bone pet chew produced with plant starch as a main raw material for the outer casing. With plant starch as a main raw material, this chew has only the characteristics of dog feed and little or no teeth grinding and chewing functions.

U.S. Patent Application No. 2006/0141105 discloses a chewable pet object with bone powder as one possible substance.

### SUMMARY OF THE INVENTION

An object of the present invention is to provide a layered pet chew in which the outer layer can be shaped and used in a laminated pet chew product, such as a dog chew.

The present invention provides a pet chew comprising: an outer layer and an inner layer, the outer and inner layers being laminated and rolled into a cylindrical shape having knots at both ends, the outer layer including bone powder.

By having the outer layer made with bone powder, other ingredients such as rawhide, can be dispensed with, while still providing a solid, nutritious and durable layered pet chew.

### BRIEF DESCRIPTION OF THE DRAWINGS

FIG. 1 is a schematic view of the product of the present invention.

### DETAILED DESCRIPTION

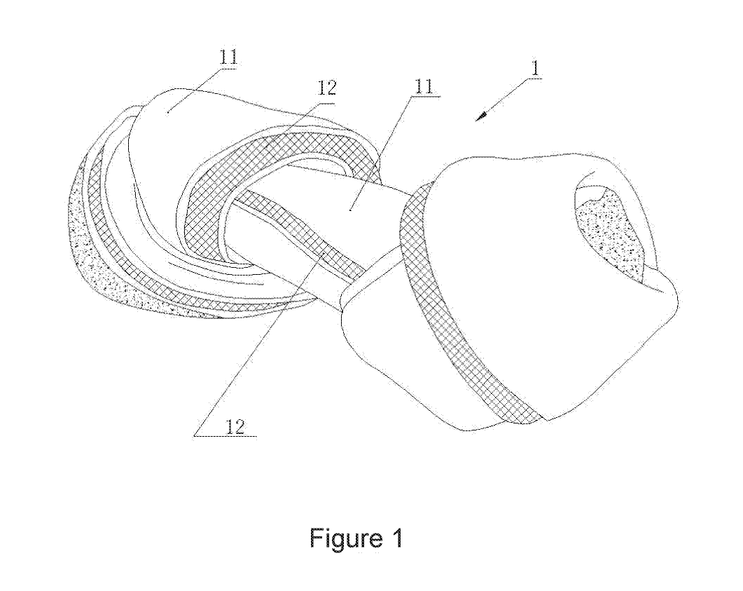

With reference to FIG. 1, the pet chew 1 released in the present invention includes an outer layer 11 and an inner layer 12. Layer 11 and layer 12 are laminated and rolled into a cylindrical shape. The resultant cylindrical body is knotted at its both ends.

The inner layer 12 preferably is made of an animal-product based jerky, most preferably chicken breast jerky.

The inner layer 12 preferably constitutes 5 to 10% of the total weight of the pet-chew 1, and most preferably about 7 percent, for example 7.2 percent.

The outer layer 11 includes bone powder, for example ox, cattle, pig or chicken bone powder, or a combination thereof.

Advantageously and surprisingly, the outer layer 11 including bone powder may be free of rawhide or other animal skin products while still maintaining good durability.

The bone powder preferably constitutes 5 to 15% of the total weight of outer layer 11, and most preferably about 10%.

In one preferred embodiment, the outer layer 11 comprises 35.6% corn starch, 9.2% wheat flour, 0.8% malt sugar, 14.3% edible glycerin from animal sources, 16.5% fresh chicken, 10.1% bone powder, 10.1% fresh beef, 1.4% colors, 1.2% edible flavors, 0.7% salt and 0.1% potassium sorbate.

The total weight of outer layer 11 from animal sources advantageously is 50% or more, providing good protein, in addition to any protein from the inner layer 12.

The proportion of fresh meat, which has excellent protein, is preferably between 20 and 30 percent, most preferably about 25%.

The proportion of edible glycerin is preferably between 10 and 20% and most preferably about 15%.

The vegetable material of the outer layer 11 preferably is between 25 and 50% so as also to provide vegetable nutrients.

Colors advantageously may be between 1 and 2% of the outer layer 11 by weight.

The present dog chew has been found to provide excellent nutritional value, while still being durable and also easily colorable.

The present dog chew may be manufactured with methods similar to those disclosed in co-assigned U.S. patent application Ser. No. 12/925,509 and having a filing date of Oct. 22, 2010, published on Apr. 5, 2012 as U.S. Patent Application U.S. 2012/0079992 A1, said application being incorporated hereby by reference herein.

What is claimed is:

1. A pet chew comprising:
an outer layer; and
an inner layer, the outer and inner layers being laminated and rolled into a cylindrical shape having knots at both ends,
the outer layer having a total weight from animal sources of 50% or more, containing bone powder and wherein vegetable material constitutes between 25 and 50% of the outer layer by weight.

2. The pet chew as recited in claim 1 wherein the inner layer is made of an animal-product based jerky.

3. The pet chew as recited in claim 2 wherein the jerky is chicken breast jerky.

4. The pet chew as recited in claim 1 wherein the inner layer constitutes 5 to 10% of the total weight of the pet-chew.

5. The pet chew as recited in claim 1 wherein the bone powder includes ox, cattle, pig or chicken bone powder.

6. The pet chew as recited in claim 1 wherein the outer layer is free of rawhide or other animal skin products.

7. The pet chew as recited in claim 1 wherein the bone powder constitutes 5 to 15% of the outer layer by weight.

8. The pet chew as recited in claim 8 wherein fresh meat constitutes between 20 and 30 percent of the outer layer by weight.

9. The pet chew as recited in claim 1 wherein fresh meat constitutes between 20 and 30 percent of the outer layer by weight.

10. The pet chew as recited in claim 1 wherein edible glycerin constitutes between 10 and 20% of the outer layer by weight.

11. The pet chew as recited in claim 1 wherein colors constitute between 1 and 2% of the outer layer by weight.
